(19) United States
(12) Patent Application Publication
(10) Pub. No.: US 2009/0121817 A1
(43) Pub. Date: May 14, 2009

(54) LINEAR SOLENOID

(75) Inventor: Ryo Ishibashi, Kariya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/265,779

(22) Filed: Nov. 6, 2008

(30) Foreign Application Priority Data
Nov. 9, 2007 (JP) 2007-292038

(51) Int. Cl. H01F 7/08

(52) U.S. Cl. 335/255

(57) ABSTRACT

An assist spring is provided between a plunger and a bottom wall of a yoke in order to bias the plunger forward. The assist spring has nonlinear characteristic to compensate a decrease in magnetic attracting force. In a range where the magnetic attracting force is weakened, the assist spring strongly biases the plunger forward and the plunger receives both of the magnetic attracting force and a biasing force of the assist spring. Therefore, a decrease in driving force of the plunger can be avoided.

### CROSS-REFERENCE TO RELATED APPLICATION

This application is based on Japanese Patent Application No. 2007-292038 filed on Nov. 9, 2007, the disclosure of which is incorporated herein by reference.

### FIELD OF THE INVENTION

The present invention relates to a linear solenoid in which a plunger is magnetically attracted to a magnetic attracting portion.

### BACKGROUND OF THE INVENTION

In a linear solenoid which attracts a plunger to a magnetic attracting portion, when the plunger moves away from the magnetic attracting portion, a magnetic attracting gap increases or a magnetic flux leaks at a thin wall portion, so that a magnetic attracting force weakens. Thus, a driving force of plunger is also weakened. That is, when the plunger moves apart from the magnetic attracting portion, the magnetic attracting force to the plunger is weakened and the driving force of the plunger is also deteriorated.

Referring to FIGS. 2A-2E, the magnetic flux leakage at the thin wall portion will be described in detail hereinafter. In FIGS. 2A-2E, an axial left side is referred to as a front side, and an axial right side is referred to a rear side. An actual mounting direction of the linear solenoid is suitably changed. An electromagnetic hydraulic control valve is provided with a spool valve 1 and a linear solenoid 2 which drives the spool valve 1. The linear solenoid 2 includes a coil 13, a plunger 14, a yoke 17, and a stator core 21.

The stator core 21 is comprised of a magnetic attracting portion 18 which magnetically attracts the plunger 14 forward, a cylindrical magnetic flux passing portion 20 which slidably receives the plunger 14 therein, and a thin wall portion 19 between the magnetic attracting portion and the magnetic flux passing portion 20. The magnetic attracting portion 18 includes a cylindrical concave portion 24 which receives a front portion of the plunger 14 when the plunger 14 is moved forward. A front portion of the cylindrical concave portion 24 is a non-tapered portion 24a of which radial thickness is constant. A rear portion of the cylindrical concave portion 24 is a tapered portion 24b of which outer diameter decreases toward the rear side.

A solid line “A” in FIG. 2B shows a relationship between a stroke quantity of the plunger 14 and a magnetic attracting force generated to the plunger 14 when the coil is gradually energized. The stroke quantity of the plunger 14 will be described hereinafter, while the front end of the plunger 14 is assumed as a reference.

As shown by the solid line “A” in FIG. 2B, when the front end of the plunger is positioned at a front side of a boundary between the non-tapered portion 24a and the tapered portion 24b, that is, when the stroke quantity is greater than a specified stroke quantity, a constant magnetic attracting force is applied to the plunger 14.

When the front end of the plunger is positioned at a rear side of the boundary, that is, when the stroke quantity is less than the specified stroke, the magnetic attracting force becomes smaller as the stroke quantity become smaller.

This reason will be explained below.

When the front end of the plunger 14 is positioned at the front sided of the boundary, that is, when the stroke quantity is greater than the specified stroke, as shown in FIG. 2C, the front end of the plunger 14 is positioned at a place facing to the non-tapered portion 24a, so that the magnetic flux passing through the thin wall portion 19 is decreased and the magnetic flux mainly passes the plunger 14. The magnetic flux leakage is decreased. Thus, the magnetic attracting force to the plunger 14 does not decrease. In this case, the magnetic attracting force is shown by “f1” in FIG. 2B.

When the front end of the plunger 14 is positioned at the rear side of the boundary, that is, when the stroke quantity is less than the specified stroke, as shown in FIG. 2D, the magnetic flux passing through the thin wall portion 19 increases and the magnetic flux passing through the plunger 14 decreases. The magnetic flux leakage is increased. Thus, the magnetic attracting force to the plunger 14 decreases. In this case, the magnetic attracting force is shown by “f2” in FIG. 2B.

In order to solve the problems described above, the thin wall portion 19 is provided with a plurality of holes 19a as shown in FIG. 2E. Such a linear solenoid is shown in JP-2001-263521A (U.S. Pat. No. 6,601,822B2). A plurality of holes 19a restricts the magnetic flux passing through the thin wall portion 19. That is, the holes 19a restrict the magnetic flux leakage. Hence, as shown by a dashed line “B” in FIG. 2B, even when the stroke quantity of the plunger 14 becomes less than the specified stroke quantity, a decrease in magnetic attracting force can be restricted. When the plunger 14 is positioned at a place shown in FIG. 2E, the magnetic attracting force is shown by “f3” in FIG. 28.

As described above, even if the holes 19a are formed at the thin wall portion 19, when the front end of the plunger is positioned at the rear side of the boundary, the decrease in magnetic attracting force can not be restricted perfectly. Furthermore, a lot of holes 19a weaken the mechanical strength of the thin wall portion 19. In order to ensure the mechanical strength of the thin wall portion 19, the number of holes 19a is restricted. If the number of the holes 19a is not enough, the magnetic flux leakage can not be restricted enough. When the front end of the plunger 14 is positioned at the rear side of the boundary, the decrease in magnetic attracting force can not be restricted enough.

### SUMMARY OF THE INVENTION

The present invention is made in view of the above matters, and it is an object of the present invention to provide a linear solenoid which is able to avoid a decrease in plunger driving force even when a plunger moves apart from a magnetic attracting portion so that the magnetic attracting force between the plunger and the magnetic attracting portion is decreased.

According to the present invention, a linear solenoid includes a plunger which is slidably supported in a first axial direction and a second axial direction, and an assist spring which is arranged between the plunger and a fixed member in order to bias the plunger in the first axial direction. The assist spring has a following nonlinear characteristic. That is, the assist spring biases the plunger in the first axial direction with a first biasing force in a region where the plunger moves away from the magnetic attracting portion to decrease the magnetic attracting force. The assist spring biases the plunger in the second axial direction with a second biasing force of which intensity is lower than that of the first force in a region where the plunger moves close to the magnetic attracting portion to increase the magnetic attracting force.

With this configuration, when the plunger moves away from the magnetic attracting portion so that the magnetic attracting force decreases, the assist spring biases the plunger to compensate the decrease in magnetic attracting force. Hence, deterioration in driving force of the plunger can be avoided.

Furthermore, both ends of the assist spring are always in contact with the plunger and the fixed member in a whole stroke range of the plunger. The plunger 14 and the spool 4 do not generate any rocking vibrations. Thus, a fluctuation in control pressure due to the rocking vibrations of the spool does not arise, and a high hydraulic control accuracy of the spool valve can be maintained.

### BRIEF DESCRIPTION OF THE DRAWINGS

Other objects, features and advantages of the present invention will become more apparent from the following description made with reference to the accompanying drawings, in which like parts are designated by like reference numbers and in which:

FIG. 1A is a cross sectional view showing an electromagnetic hydraulic control valve;

FIG. 1B is a cross sectional view showing an essential part of the linear solenoid valve;

FIG. 1C is a graph showing a relationship between a plunger stroke and a force acting on the plunger;

FIG. 2A is a cross sectional view showing a conventional electromagnetic hydraulic control valve;

FIG. 2B is a graph showing a relationship between a plunger stroke and a force acting on the plunger in the conventional electromagnetic hydraulic control valve; and

FIGS. 2C-2E are cross sectional views showing an essential part of a conventional linear solenoid valve.

### DETAILED DESCRIPTION OF EMBODIMENTS

### First Embodiment

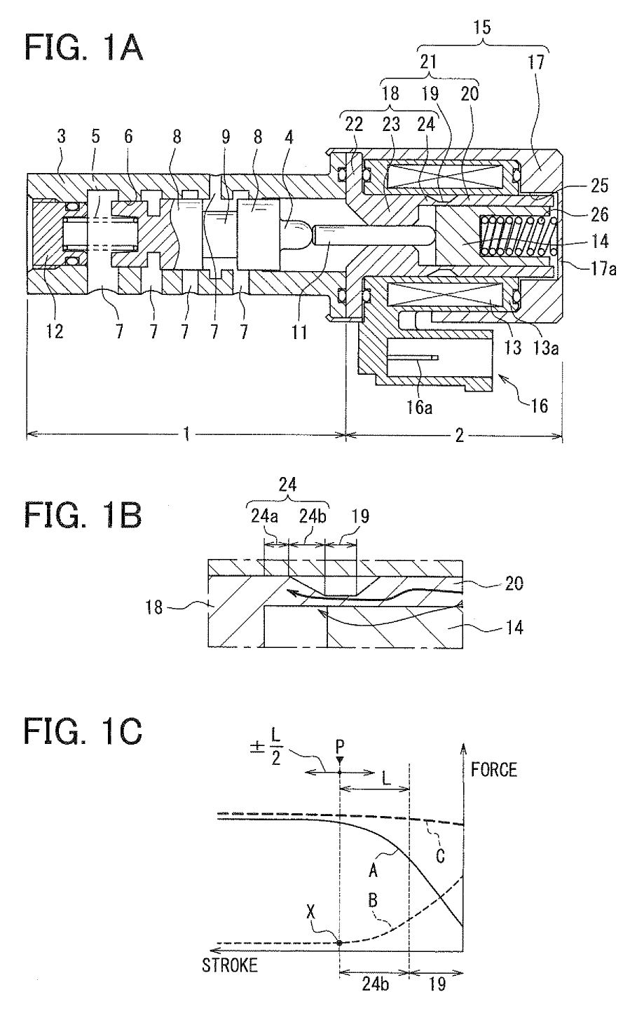

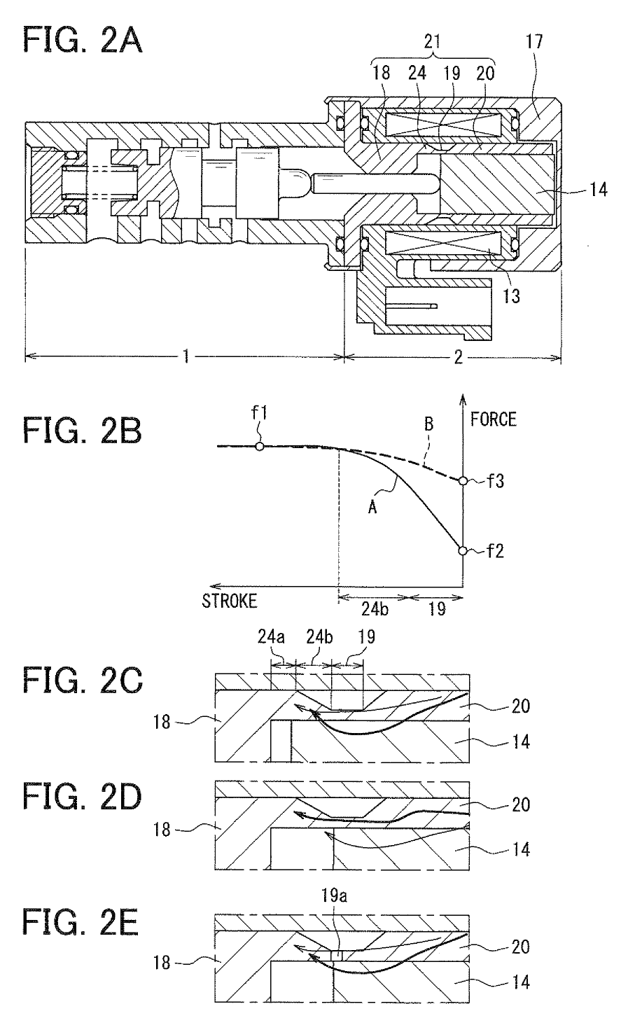

Referring to FIGS. 1A-1C, a first embodiment will be described hereinafter, (Structure of electromagnetic hydraulic control valve)

An electromagnetic hydraulic control valve can be applied to a hydraulic control apparatus of an automatic transmission, for example. The electromagnetic hydraulic control valve is referred to as an EHC valve, hereinafter. Specifically, in a first embodiment, the EHC valve is arranged in a case of a hydraulic controller. The EHC valve is provided with a spool valve 1 and a linear solenoid 2 which drives the spool valve 1.

### (Explanation of Spool Valve 1)

The spool valve 1 is provided with a sleeve 3, a spool 4 and a return spring 5 (biasing means). The sleeve 3 is substantially cylindrical. The sleeve 3 is provided with a through-hole 6 in which the spool 4 is slidably supported. The sleeve 3 is provided with a plurality of oil ports 7. The oil ports 7 include an input port communicating with an oil pump (not shown), an output port for discharging an output pressure, a discharge port communicating with a drain pan (not shown), and a drain port.

The spool 4 is slidably arranged in the sleeve 3 to vary an opening area of each oil port 7 and switch a communicating condition of the oil ports 7. The spool 4 is provided with a plurality of lands 8 and small-diameter portions 9 between adjacent lands. A rear end of the spool 4 is in contact with a shaft 11 which extends to an interior of the linear solenoid 2. A rear end of the shaft 11 is in contact with a front end surface of the plunger 14, whereby the plunger 14 drives the spool 4 in an axial direction.

The return spring 5 is a compression coil spring which biases the spool 4 backward. The return spring 5 is disposed in a spring chamber of the sleeve 3 in such a manner as to be compressed. A rear end of the return spring 5 is in contact with a front surface of the spool 4, and a rear end of the return spring 5 is in contact with a bottom surface of an adjusting screw 12 which closes a front end of the through-hole 6. A biasing force of the return spring 5 is adjusted by the adjusting screw 12.

### (Explanation of Linear Solenoid 2)

The linear solenoid 3 is provided with a coil 13, a plunger 14, a magnetic stator 15, and a connector 16. When the coil 13 is energized, the coil 13 generates a magnetic flux loop through the plunger 14 and the magnetic stator 15. The coil 13 is wound around a bobbin 13a made of resin material.

The plunger 14, which is column-shaped, is made of magnetic metal such as iron. The plunger 14 is in contact with an inner surface of the magnetic stator 15 in such a manner as to slide thereon. As described above, the front end surface of the plunger 14 is in contact with the rear end of the shaft 11. Thus, the plunger 14 and the spool 4 are biased backward by the biasing force of the return spring 5. The plunger 14 is provided with a breathing aperture (or breathing groove) which penetrates the plunger 14 in the axial direction.

The magnetic stator 15 is comprised of a cup-shaped yoke 17 made of magnetic material, and a stator core 21 which includes a magnetic attracting portion 18, a thin wall portion 19, and a magnetic flux passing portion 20. The yoke 17 covers the outer surface of the coil 13. The stator core 21 is made of magnetic material. The stator core 21 is inserted into the yoke 17 from its opening end and is fixed with the sleeve 3 at the opening end of the yoke 17.

The yoke 17 has a nail position at its opening end. This nail portion is caulked so that the yoke 17 is connected with the sleeve 3 firmly.

The magnetic attracting portion 18 is comprised of a flange portion 22 which is magnetically connected with an opening end of the yoke 17, a magnetic confronting portion 23 which axially confronts to the plunger 14, and a cylindrical concave portion 24 into which a front end portion of the plunger 14 moves. The magnetic attracting portion 18 is made of magnetic metal such as iron. The magnetic attracting portion 18 and the plunger 14 form a magnetic attracting gap therebetween. The magnetic confronting portion 23 is provided with a breathing aperture (or breasing groove) which penetrates the magnetic confronting portion 23 in the axial direction. In this embodiment, the magnetic attracting portion 18 is integrally formed with the flange portion 22. Alternatively, the flange portion 22 can be made as a separate unit, and then the flange portion 22 can be connected with the magnetic confronting portion 23 by press-inserting.

Referring to FIG. 1B, the cylindrical concave portion 24 will be specifically described hereinafter.

A front portion of the cylindrical concave portion 24 is a non-tapered portion 24a of which radial thickness is constant. A rear portion of the cylindrical concave portion 24 is a tapered portion 24b of which outer diameter decreases toward the rear side. The tapered portion 24b is formed in order to restrict a variation in magnetic attracting force with respect to a stroke quantity of the plunger 14. When the plunger 14 is most lifted, that is, when the plunger 14 is magnetically attracted most forward, the front end of the plunger moves from an inside of the thin wail portion 19 to an inside of the non-tapered portion 24a through an inside of the tapered portion 24b.

The thin wall portion 19 has a radial thickness which is thinner than that of the other portion. This thin wall portion 19 is a magnetic saturating portion which interrupts a direct flow of the magnetic flux between the magnetic attracting portion 18 and the magnetic flux passing portion 20.

The magnetic flux passing portion 20 is a cylindrical portion which covers an entire circumference of the plunger 14. The magnetic flux passing portion 20 is made of magnetic metal such as iron, and is inserted into a concave portion 25 of the yoke 17. Thus, the magnetic flux passing portion 20 is magnetically connected with the yoke 17. The plunger 14 slides on the inner surface of the magnetic flux passing portion 20. The magnetic flux radially flows between the magnetic flux passing portion 20 and the plunger 14. A magnetic gap is formed between the magnetic flux passing portion 20 and the plunger 14.

The connector 16 includes a terminal 16a to be connected with an electronic control unit (not shown) through an electric line.

### Background of the First Embodiment

As the electric current applied to the coil 13 increases, the magnetic attracting force increases. The magnetic flux passing through the plunger 14 and the magnetic stator 15 increases, so that the plunger 14 is magnetically attracted forward. As shown by a solid line “A” in FIG. 1C, as the front end of the plunger 14 moves backward from a boundary between the non-tapered portion 24a and the tapered portion 24b, the magnetic attracting force to the plunger 14 is decreased.

Specifically, when the front end of the plunger 14 is positioned at a place facing to the non-tapered portion 24a, a constant magnetic attracting force is generated to the plunger 14. When the front end of the plunger 14 is positioned at a place facing the tapered portion 24b, the magnetic attracting force generated to the plunger decreases. When the front end of the plunger 14 is positioned at a place facing to the thin wall portion 19, the magnetic attracting force decreases further.

As shown in FIG. 1B, when the front end of the plunger 14 is positioned at the place facing to the tapered portion 24b or the thin wall portion 19, the magnetic flux passing through the thin wall portion 19 increases and the magnetic flux passing through the plunger decreases, so that the magnetic attracting force generated to the plunger 14 is decreased.

### Feature of First Embodiment

According to the first embodiment, the linear solenoid 2 is provided with an assist spring 26 between the plunger and a bottom wall 17a of the yoke 17. The assist spring 26 biases the plunger 14 forward. This assist spring 26 is a compression coil spring which compensates the deterioration of the magnetic attracting force. As shown by a dashed line “B” in FIG. 10, the assist spring 26 has a nonlinear characteristics as follows:

(i) When the front end of the plunger 14 is positioned at the place facing to the tapered portion 24b or the thin wall portion 19, the assist spring 26 biases the plunger 14 forward strongly.

(ii) When the front end of the plunger 14 is positioned at the place facing to the non-tapered portion 24a, the assist spring 26 biases the plunger 14 forward weakly.

The strong biasing force is changed to the weak biasing force at a changing point “X” in FIG. 1C. This changing point “X” corresponds to a point which divides a region into a weak magnetic attracting force region and a strong magnetic attracting force region. This changing point “X” of the assist spring 26 is established at a position where the front end of the plunger 14 is positioned at a front side of the boundary between the tapered portion 24b and the thin wall portion 19.

In a case that the axial length of the tapered potion 24b is denoted by “L” and a boundary between the non-tapered portion 24a and the tapered portion 24b is denoted by “P”, the changing point “X” is established in a range of ±L/2 with respect to the boundary “P”. More preferably, as shown in FIG. 1C, the changing point “X” is established at the position where the front end of the plunger 14 is positioned at the boundary “P” between the non-tapered portion 24a and the tapered portion 24b.

A characteristic of the assist spring 26 will be specifically described hereinafter.

As described above, when the front end of the plunger 14 is positioned at the place facing to the tapered portion 24b (position α), the magnetic attracting force generated to the plunger 14 is decreased. When the front end of the plunger 14 is positioned at the place facing to the thin wall portion 19 (position β), the magnetic attracting force generated to the plunger 14 is further decreased. The assist spring 26 is the compression coil spring having the characteristic in which the decrease in magnetic attracting force is compensated. The biasing force of the assist spring 26 when the plunger is positioned at the position α is greater than the biasing force of the assist spring 26 when the plunger is positioned at the position β.

In a case that the plunger 14 moves backward from the maximum lift position, until the front end of the plunger 14 reaches the boundary between the non-tapered portion 24a and the tapered portion 24b, the biasing force of the assist spring 26 is very weak. Until the front end of the plunger 14 reaches the boundary between the tapered portion 24b and the thin wall portion 19, the biasing force of the assist spring 26 becomes gradually strong. And then, as the rear end of the plunger comes close to the bottom wall 17a, the biasing force of the assist spring 26 becomes significantly strong.

The assist spring 26 has the nonlinear characteristics by means of well-known technology. For example, a diameter of the spring wire is varied, a winding diameter of the spring is varied, or a plurality of coil springs having different characteristics are aligned in series.

The front end portion of the assist spring 26 is arranged in a concave portion of the plunger 14. Both ends of the assist spring 26 are always in contact with the plunger 14 and the bottom wall 17a respectively in a whole stroke range of the plunger 14.

### Advantage of First Embodiment

As described above, according to the first embodiment, the linear solenoid 2 is provided with the assist spring 26 which has the nonlinear characteristics as shown by the dashed line “B” in FIG. 1C.

With this configuration, when the plunger 14 moves away from the magnetic attracting portion 18 so that the magnetic attracting force decreases, the assist spring 26 biases the plunger 14 strongly forward to compensate the decrease in magnetic attracting force. As the result, as shown by the dashed line “C” in FIG. 1C, both of the magnetic attracting force and the biasing force of the assist spring 26 are applied to the plunger 14, whereby the driving force of the plunger 14 can be maintained constant in the whole stroke of the plunger 14. That is, according to an energization of the coil 13, the displacement of the plunger 14 can be linearly controlled, so that the control accuracy of the spool valve 1 can be enhanced.

Furthermore, since both ends of assist spring 26 are always in contact with the plunger 14 and the bottom wall 17a respectively, the plunger 14 and the spool 4 do not generate any rocking vibrations. Thus, a fluctuation in control pressure due to the rocking vibrations of the spool 4 does not arise, and a high hydraulic control accuracy of the spool valve 1 can be maintained.

### [Modification]

The thin wall portion 19 may have a plurality of holes to restrict the magnetic flux leakage.

In the first embodiment, the magnetic attracting portion 18 confronts to the plunger 14 in the axial direction. Alternatively, the magnetic attracting portion 18 can be provided with a through-hole through which the plunger slides.

In the first embodiment, the magnetic attracting portion 18 and the magnetic flux passing portion 20 are integrally formed. Alternatively, the magnetic attracting portion 18 and the magnetic flux passing portion 20 can be formed as separate units. That is, the present invention can be applied to a linear solenoid 2 which does not have the thin wall portion 19.

In a case that a ball valve is used as a valve body, the plunger 14 may be biased backward by hydraulic pressure.

The present invention can be applied to any electromagnetic hydraulic control valve for an apparatus other than automatic transmission. The present invention can be applied any electromagnetic valves other than the electromagnetic hydraulic control valve. The linear solenoid 2 can drive any objects other than the valve (the spool valve 1 in the embodiment).

What is claimed is:

1. A linear solenoid including a coil which generates magnetic attracting force when energized, a plunger which is slidably supported in an axial direction thereof, a magnetic attracting portion which magnetically attracts the plunger in a first axial direction by the magnetic attracting force, a magnetic flux passing portion which is provided around the plunger to transmit/receive a magnetic flux therebetween, and a biasing means for biasing the plunger in a second axial direction, the linear solenoid comprising:
an assist spring which is arranged between the plunger and a fixed member in order to bias the plunger in the first axial direction, wherein
the assist spring has nonlinear characteristic in which the assist spring biases the plunger in the first axial direction with a first biasing force in a region where the plunger moves away from the magnetic attracting portion to decrease the magnetic attracting force, and the assist spring biases the plunger in the first axial direction with a second biasing force of which intensity is lower than that of the first force in a region where the plunger moves close to the magnetic attracting portion to increase the magnetic attracting force, and
both ends of the assist spring are always in contact with the plunger and the fixed member in a whole stroke range of the plunger.

2. A linear solenoid according to claim 1, wherein
a changing point where the biasing force of the assist spring is changed between the first biasing force and the second biasing force is established at a changing portion where the magnetic attracting force is changed between high level and low level.

3. A linear solenoid according to claim 1, wherein
the magnetic attracting portion is provided with a cylindrical concave portion into which a front end of the plunger moves when the plunger moves in the first axial direction,
the cylindrical concave portion is comprised of a non-tapered portion of which radial thickness is constant and a tapered portion of which outer diameter is increased in the second axial direction, the non-tapered portion is arranged in the first axial direction relative to the tapered portion, and
in a case that an axial length of the tapered portion is denoted by “L”, and a boundary between the non-tapered portion and the tapered portion is denoted by “P”, a changing point where the biasing force of the assist spring is changed between the first biasing force and the second biasing force is established in a range where the front end of the plunger is positioned at ±L/2 with respect to the boundary “P”.

4. A linear solenoid according to claim 1, wherein
the magnetic attracting portion is provided with a cylindrical concave portion into which a front end of the plunger moves when the plunger moves in the first axial direction,
the cylindrical concave portion is comprised of a non-tapered portion of which radial thickness is constant and a tapered portion of which outer diameter is increased in the second axial direction, the non-tapered portion is arranged in the first axial direction relative to the tapered portion, and
the magnetic attracting portion and the magnetic flux passing portion are integrally formed through a thin wall portion of which radial thickness is smaller than that of the other portion.

5. A linear solenoid according to claim 1, wherein
the linear solenoid drives a valve unit which performs a fluid quantity control or a fluid pressure control.
